(19) United States
(12) Patent Application Publication
(10) Pub. No.: US 2011/0016770 A1
(43) Pub. Date: Jan. 27, 2011

(54) METHOD FOR COMBINED APPLICATION OF TWO SUBSTANCES FOR SIMULTANEOUS PREVENTION AND MONITORING OF DIFFERING TYPES OF PEST

(76) Inventor: Sven Buchholz, Berlin (DE)

Correspondence Address: JOYCE VON NATZMER;PEQUIGNOT + MYERS LLC, 200 Madison Avenue, Suite 1901, New York, NY, 10016, US

(21) Appl. No.: 12/918,041

(22) PCT Filed: Feb. 17, 2009
(86) PCT No.: PCT/DE09/00223

§ 371 Date: Oct. 5, 2010

Related U.S. Application Data
(60) Provisional application No. 61/105,098, filed on Oct. 14, 2008.

(30) Foreign Application Priority Data
Feb. 18, 2008 (DE) 10 2008 009 666.0
May 26, 2008 (EP) 08075518.4

(51) Int. Cl. A01M 1/20; A01N 59/00; A01N 59/06; A01P 7/02; A01P 7/04

(52) U.S. Cl. 43/107; 424/724; 424/722

(57) ABSTRACT

The idea of the combination trap is to enable an apiarist to simultaneously control two bee pests in a single operation. In places where one of the pests does not yet occur, the trap serves in monitoring and prevention. The trap comprises a mechanically simple apparatus and two active substances.

The invention relates to a combination agent and a method of destroying pests of bees.

A variety of methods for minimizing or destroying bee pests have been described in the prior art. Well-known methods are disadvantageous in that not all of the pests can be minimized and destroyed, or that the agents or devices involve drawbacks with respect to the quality of the honey, or that they are harmful to the bees.

Bees have great importance from both a business and economic standpoint. Being industrially farmed animals, bees on the one hand are a global supplier of a variety of products such as honey, pollen, wax, propolis and royal jelly. Bee products have generated direct sales of about one quarter of a billion euros per year in Germany alone. On the other hand, bees provide about 80% of all pollination of crop and wild plants worldwide. The U.S. Department of Agriculture estimates the total value of insect-related yield increase in 95 kinds of fruits and vegetables to be about 14.6 billion U.S. dollars.

In view of the over-proportional dying of bees in the USA, which threatens to spread to Europe, Asia and Africa, there is an increased need for reliable monitoring and development of effective control strategies against bee diseases and pests. Various studies have shown that the parasitic bee mite (Varroa destructor) and the small hive beetle (Aethina tumida) are particularly pathogenic parasites, although they have not occurred everywhere in the world as yet.

The varroa mite has its origins in some regions of Asia and meanwhile has caused billions in damage worldwide. The small hive beetle has been introduced from Africa into the USA, Canada, Australia and some regions of the Middle East and has likewise caused great damage. In many countries the above-mentioned parasites already occur simultaneously. To allow optimum response in a situation where the above two bee pests are occurring, accurate monitoring on the one hand and subsequent targeted destruction thereof are required using agents or devices that would not adversely affect the quality of the honey and the physiology of the bees.

Pests are usually introduced by dispersal. As a consequence of insufficient defense mechanisms of the beneficial animal and absence of natural enemies of the pest, the latter is spreading rapidly and epidemically. In addition, the two parasites (varroa mite and small hive beetle) have adapted very efficiently to their host and exhibit exponential distribution rates. This development is even enhanced if the parasite can spread unobserved in a region at the beginning of its invasion. For this reason as well, there is an increased need for control strategies which comprise monitoring, prevention and destruction. Monitoring serves in continuous and early detection of a pest. Prevention serves in early containment of a possible pest infestation, while control involves the objective of keeping the pest steadily below a particular damage threshold. At present, various products are being used in these different subranges mentioned above, which cannot be used in combination.

The object of the invention is therefore to provide devices, agents and methods by means of which a plurality of bee pests can be monitored, contained and/or combated at the same time.

Quite surprisingly, it was found that the object of the invention can be accomplished by means of a combined agent comprising an organic acid, preferably formic acid and/or acetic acid, and silicates, in particular kieselguhr, preferably diatomaceous earth, and/or a calcium compound, preferably hydrated lime.

Organic acids in the meaning of the invention are organic chemical compounds which have a functional group and undergo an equilibrium reaction with water or other protonatable solvents. Formic acid, which is preferred, is the shortest chain alkanoic acid. Apart from the preferred formic acid, it also is possible to use acetic, or ethanoic, acid. The organic acids are preferably used together with silicates. For example, silicates according to the invention can be classified according to the degree of polymerization of the SiO₄ tetrahedra, e.g. island silicates, group silicates, ring silicates, single- and double-chain silicates, sheet silicates, framework silicates or amorphous silicates. A particularly preferred silicate is kieselguhr. In the meaning of the invention, kieselguhr is classified into white, gray and green kieselguhr. In a particularly preferred fashion, diatomaceous earth is used as kieselguhr. Diatomaceous earth in the meaning of the invention is understood to be a diatomaceous earth that is familiar to those skilled in the relevant art. On the other hand, it is also possible to use calcium compounds, preferably lime, in particular hydrated lime and/or quicklime, instead of kieselguhr in the combination agent. Instead of the substances mentioned above, it is also possible to use salts, as familiar to those skilled in the art, in particular inorganic salts, preferably sodium chloride (common salt) or sodium carbonate (soda ash), in the combination agent.

In a preferred embodiment of the invention the active ingredients of the combined agent, i.e. formic acid and diatomaceous earth, are spatially separated from each other. For example, spatial separation may imply that the formic acid and diatomaceous earth have no contact with each other because e.g. the diatomaceous earth has been positioned, e.g. scattered, around a liquid film of formic acid. On the other hand, spatial separation in the meaning of the invention may imply that the formic acid and diatomaceous earth are present in combination in such a way that a small amount of the diatomaceous earth is moistened by formic acid.

For example, spatial separation can be achieved in that the formic acid is present in a test tube or a flask and the diatomaceous earth is present around the opening of the flask or test tube. A person skilled in the art will be familiar with further distinct embodiments of this advantageous embodiment of the invention. When using microtiter plates, for example, one well can be filled with formic acid and another alternately with diatomaceous earth. Further advantageous embodiments can be inferred from the examples, according to which the formic acid is present in a fabric around which the diatomaceous earth is arranged.

The teaching according to the invention represents a combination invention intended for technical practice, wherein the preferred elements, diatomaceous earth and formic acid, cooperate to achieve the overall technical success. As a result of this combination, there is a functional interaction of the elements of the combination invention such that a synergistic effect in terms of reducing, monitoring or detecting bee pests is achieved. The elements combined in the combination agent cooperate to achieve a common objective. The preferred formic acid and the diatomaceous earth—as well as other possible components of the combined agent—have an influence on each other, and the overall success of the invention is furnished as a result of their mutual complementarity. Consequently, the elements of the combination agent are functionally combined in terms of treatment or monitoring of bee pests. Quite surprisingly, the combination of organic acids, preferably formic acid, and silicates and/or calcium compounds has a completely unexpected effect in controlling different species of bee pests, and this combination agent does not involve the disadvantages of the prior art.

In a particularly preferred embodiment of the invention the combination agent according to the invention is employed as a pharmaceutical agent, particularly for the destruction of bee pests. As is well-known to a person of average skill in the art, the pharmaceutical agent may include further carrier substances. These further carrier substances include fillers, dissolution retarders, disintegrants, absorption enhancers, wetting agents, absorbents, lubricants and/or carrier lipids, especially solid lipid nanoparticles, nanostructured lipid carriers, liposomes or polymer particles.

In another preferred embodiment of the invention the bee pests are Varroa destructor, Aethina tumida and/or Galleria mellonella. In a preferred fashion the varroa mite is a mite which invades the brood of honey bees, but on the other hand, mites situated in particular on adult bees can also be varroa mites in the meaning of the invention (Varroa destructor). Accordingly, Varroa destructor is a preferred bee pest. In the meaning of the invention, however, all mites of the Varroidae family can be treated, i.e. destroyed or observed. In the meaning of the invention the small hive beetle (Aethina tumida) is any gloss beetle (Nitidulidae), preferably from the genus Aethina, which can act as a bee parasite, but the species Aethina tumida is preferred. The great wax moth (Galleria mellonella) is a small butterfly—a moth inactive during the day—which is often found in beehives. In particular, the young caterpillars of this moth can penetrate the honeycombs. In addition to the great wax moth, all small butterflies of the Galleria genus or the subfamily of wax moths, also including the small wax moth (Achroea grisella), can be destroyed, observed and/or minimized as bee pests according to the invention.

The invention also relates to a kit comprising the combination agent in the meaning of the invention and optionally instructions for combining the contents. The relevant information need not be directly present within the kit, but the kit may include an internet address where the user is forwarded to data on the internet relating to the use of the combination agent and/or method according to the invention.

The invention also relates to the use of the combination agent of the invention and/or the kit of the invention for the prophylactic and/or therapeutic treatment of bees, particularly for the control of bee pests. It is of course also possible to use the kit and combination agent in monitoring pests of bees.

In an additional, particularly preferred aspect the invention relates to a combination trap, preferably for at least two different types and/or individuals of bee pests, which combination trap has at least the combination agent according to the invention. In the meaning of the invention, control of bee pests is invariably understood to include the treatment or monitoring of bee diseases.

In a preferred embodiment the combination trap has at least one essentially rectangular container which is divided by a barrier-like vertical center wall into at least two container portions, preferably situated in a horizontal plane, such that mixing of the preferred formic acid and the preferred diatomaceous earth is made impossible.

For example, it can be envisaged that a first container portion is a reservoir, closed on all sides, intended to accommodate the formic acid. The closed reservoir serves to hold the evaporative liquid which in a preferred embodiment is the organic acid, particularly formic acid. Another preferred embodiment of the invention envisages that the center wall is arranged substantially rectangularly and in such a way that a small, preferably rectangular area is delineated in the horizontal plane of the container and a small defined area is positioned essentially centrally in the horizontal plane of the container. In a particularly preferred fashion the area includes a fabric which is contacted preferably with formic acid such that it absorbs the formic acid and ensures evaporation thereof. The fabric can be a wick, for example.

The fabric structure, or the fabric as evaporation element, preferably comprises of an absorbent material selected from the group comprising paper, cardboard, ceramic, foam, woven or nonwoven textile material such as felt fleece and/or spun thread. It is of course also possible that the absorbent material comprises the above-mentioned structures, i.e. includes additional materials.

Also preferred is a combination trap wherein the horizontal plane of the container, which substantially encloses a smaller, defined area, has diatomaceous earth. This implies that, in the meaning of the invention, the container in fact may have a few interruptions. Preferably, however, these interruptions of the delineating area are not so extensive as to cause complete mixing of the diatomaceous earth and the preferred formic acid, or acetic acid.

It can also be preferred that the smaller, defined area is a pan covered with a wrap. The pan in the meaning of the invention is exemplified in the appended figures. The wrap serves to prevent contact of beneficial animals, especially bees, with the active substances of the combination agent. The wrap may have, for example, slits, holes and/or meshes preventing bees from passing through and designed in such a way that little or preferably no diatomaceous earth is swirled up from the trap by air flow swirls, especially in a beehive. Without any inventive effort, a person skilled in the art can determine the structure and size of the slits, holes and/or meshes using routine tests.

In a particularly preferred fashion the materials of the combination trap comprise acid-proof substances such as plastic or metal.

In another aspect the invention relates to the use of the inventive combination trap in monitoring and/or control of bee pests. In a preferred fashion the combination trap can also be used for the prevention or protection of regions or beehives not yet infested with Aethina tumida and/or Varroa destructor.

In a preferred fashion the combination trap can also be used for the prevention of or protection from bee pests outside a beehive, particularly in stock buildings. In this preferred embodiment the organic acid is in particular acetic acid.

Consequently, the invention also relates to a method for controlling Varroa destructor, Aethina tumida and/or Galleria mellonella in a beehive, in which method in a container having two spatially separated reservoirs an essentially constant level of evaporative liquid is generated in one of said reservoirs, or an essentially constant level of an evaporation rate is generated, said evaporative liquid comprising an organic acid, preferably formic acid, and the second spatially separated zone comprising silicates, diatomaceous earth, calcium compounds, preferably hydrated lime, and/or synthetic amorphous silicas, and the reservoir with evaporative liquid being enclosed by the second zone essentially completely. “Essentially” in this context means that the second zone encloses the reservoir, but with the option of introducing small gaps in the surrounding wall. The invention will be illustrated with reference to various examples below.

The idea of the combination trap is to enable an apiarist to simultaneously control two or more bee pests in a single operation. In places where one of the pests does not yet occur, the trap serves in monitoring and preventing the other pest. The trap comprises of a mechanical apparatus and various active substances.

At the same time, the method of evaporating the active substance creates a space wherein a pest comes in contact with another active substance that destroys the pest.

Preferred is a shallow pan, a bulge surrounding an area in the middle, in the center of which the active substance (organic acid) evaporates via a wick.

Formic acid is used to kill the parasitic bee mite (Varroa destructor). The acid vapors spread in the beehive e.g. via a wick and kill the varroa mites. The organic acid, preferably formic acid, penetrates the capped honeycombs and destroys the breeding place of the mites.

Diatomaceous earth destroys the wax layer of arthropods and penetrates their exoskeleton (cuticle), thereby eliminating the evaporation barrier. The pest dries within a few hours. Diatomaceous earth is non-specific in its effect and therefore would also kill the bees upon contact. For this reason, a preferred embodiment uses a mechanical procedure, e.g. a screen cover, to make sure that the bees cannot come in contact with the diatomaceous earth. This can be achieved because the beetle is much smaller than the bee.

To introduce the preferred apparatus, the storeys on the bottom board are tilted so as to form an opening between the hive bottom and the first frame. Alternatively, the existing flight hole (entrance/exit on the hive front) of the beehive is used to this end.

To introduce the preferred apparatus between the storeys, preferably the frames are tilted so as to form an opening between overlapping frames. Through this opening, one apparatus at a time is placed on the comb ways of each lower frame.

The apparatus can be placed, exclusively or additionally, on top of the upper-most comb ways beneath the hive cover. The comb ways of a frame, well-known to those skilled in the art, are the spatial gaps between the comb frames positioned vertically adjacent to each other and the spatial vertical gaps between each outermost comb frame and the longitudinally adjacent wall of the beehive. In the comb ways the bees are moving over the cells of the honeycombs.

For example, the use of the combination trap can be divided into three central issues:

1. Control of the two pests varroa mite (Varroa destructor) and hive beetle (Aethina tumida)

2. Monitoring of the two pests both in already affected areas and, especially, in areas not yet affected

3. Prevention of and protection from pests in hitherto unaffected areas

### Further Embodiments

A relatively large amount of formic acid can be stored in a reservoir which is either integrated in the trap or directly connected to the wick via a capillary. Alternatively, the reservoir is mounted on the outside of the beehive and the acid is passed to the wick via a pipe system. In this way, the amount of work for the apiarist is reduced because repeated replenishing the formic acid is not required.
The trap can be used outside the beehive in storage rooms where honeycombs, wax etc. are stored and the wax moth must be combated. In this area the combination trap can be equipped with acetic acid (against the wax moth) and diatomaceous earth (against the small hive beetle).
Depending on the dimensions of the apparatus, other fields of application are conceivable for interior rooms of any type: stock protection, material protection, hygienic sector, control and monitoring of pests and nuisance pests.
In addition, the apparatus can be used in greenhouses to protect ornamental and crop plants from pests.
Moreover, the apparatus can be used in roofed form against pests in the field.

Also preferred is a method for the combined use of two substances in the simultaneous control of various pest species. Inter alia, the method can be employed inside and/or outside the beehive (e.g. against the parasitic bee mite, Varroa destructor, the small hive beetle, Aethina tumida, the wax moth, Galleria mellonella).

The apparatus invented to this end preferably comprises of a shallow pan (1) which has a raised vertical bulge (2) on its horizontal surface. The bulge prevents mixing of the two substances. A fabric (4) functioning as a wick, which is soaked with active substance (e.g. an organic acid), is situated in the area (3) defined by the bulge. The acid is released in the ambient air by evaporation. The amount of evaporating substance is regulated by the physical properties of the wick (size, material, etc.).

The horizontal pan surface (5) surrounding the bulge is provided with the active ingredient (e.g. diatomaceous earth, hydrated lime) which kills arthropods.

A grid (6) with a wrap on all sides to cover the pan (1) prevents direct contact of beneficial animals (bees) with the substances. The slit width/mesh size of the cover is selected such that pests having a smaller body size than bees enter the trap, e.g. lured by the active substance I. It is here (5) where they are killed by the active substance II. The grid has properties which break the air flow from the outside and prevents non-volatile active substance(s) from escaping the trap by turbulence.

A spacing between the grated lid and the compartments, individually adjusted to the size and motor behavior of the pests (jumping, crawling, flying, creeping, etc.) prevents pests having entered the trap from escaping.

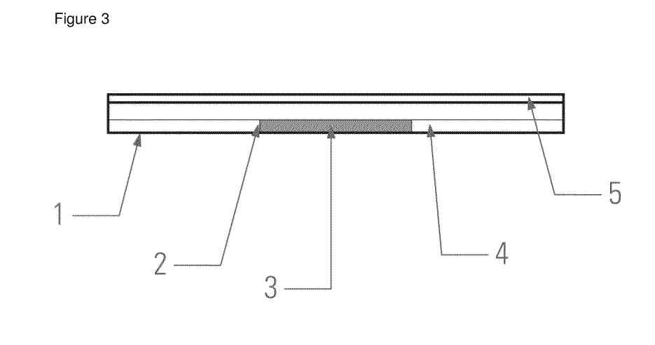

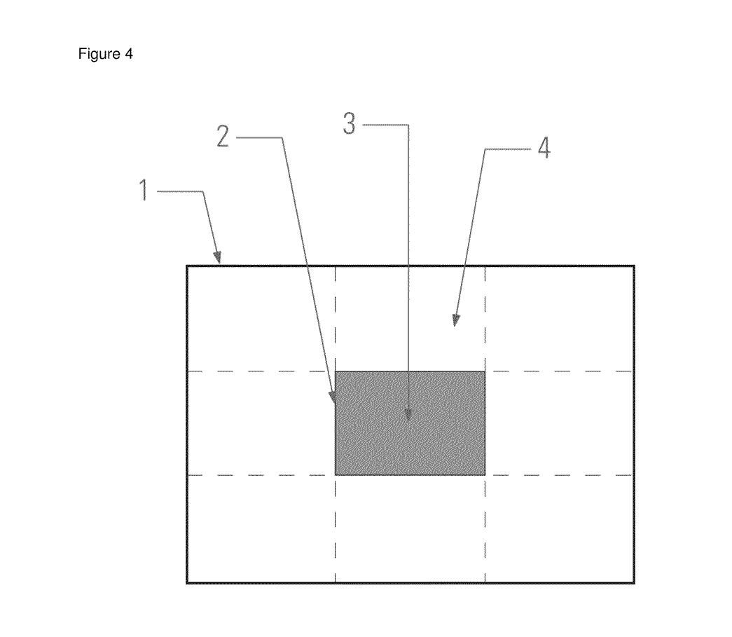

Another preferred embodiment of the apparatus according to the invention is shown in FIGS. 3 and 4 and comprises of a shallow box (1) which can be divided into different compartments optionally having different sizes (2 and 4). Each compartment may include a specific active substance. The box bottom (4) itself represents a compartment which may include an active substance. Compartmentalization of the active substances prevents mixing thereof. In one compartment there is e.g. a fabric (3) functioning as a wick, which is soaked with active substance (e.g. an organic acid). The acid is released in the ambient air by evaporation. The amount of evaporating substance is regulated by the physical properties of the wick (size, material, etc.).

A lid (5) provided with a grid and intended to cover the box (1) prevents direct contact of beneficial animals (bees) with the substances. The slit width/mesh size of the cover is selected such that pests having a smaller body size than the beneficial animals (e.g. bees or ladybirds) enter the trap, e.g. compartment (2), lured by the active substance I, for example. It is here (4) where they are killed by the active substance II. The grid has properties which break the air flow from the outside and prevents non-volatile active substances from escaping the trap by turbulence. A spacing between the grated lid and the compartments, individually adjusted to the size and motor behavior of the pests (jumping, crawling, flying, creeping, etc.) prevents pests having entered the trap from escaping.

Depending on the type of application, the box can be placed horizontally, vertically or at an angle to the support.

### Setup and Operation

The new method for the simultaneous control of different pests has a modular setup. The modules to be used are placed, preferably mounted, on a support structure (body). The body itself is a module/container wherein one or more modules are placed and an active substance can simultaneously be applied on the bottom surface not covered by the modules.

The substance on the bottom surface of the body is used to immobilize and/or destroy pests having entered the trap.

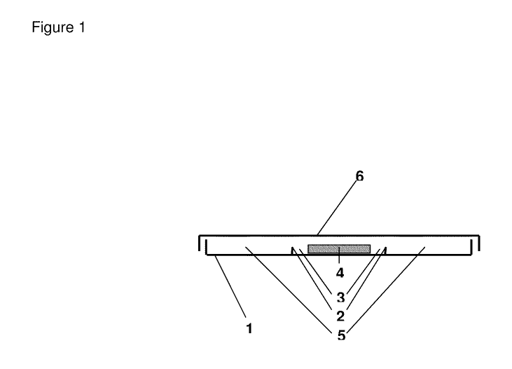

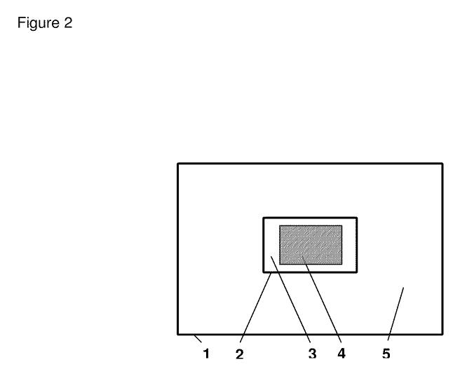

Alternatively, the structure of the body is as shown in FIGS. 1 and 2 and described above.

The module for evaporating a volatile substance is a container placed on the bottom surface of the body. The container is a reservoir for the substance to be evaporated, namely, a liquid, e.g. an organic acid such as formic acid or acetic acid, a gel containing e.g. thymol or formic acid, or a solid, e.g. thymol crystals.

Evaporation of the substance, e.g. the liquid or gel, proceeds via a fabric functioning as a wick. The amount of evaporating substance is regulated by the physical properties of the wick (size, material, etc.). The wick that is used is a fabric designed as evaporation element and preferably an absorbent material selected from the group comprising paper, cardboard, ceramic, foam, woven or nonwoven textiles such as felt, fleece, or spun thread.

If a solid is used, evaporation thereof proceeds via the surface thereof. The evaporation rate in this case is regulated by adapting the size of the correspondingly exposed surface to the desired amount of evaporation. This can be accomplished by using a cover familiar to those skilled in the art, preferably in the form of a perforated film or other covering structure.

The evaporating substance can function in two ways: it has a destroying and/or repelling effect on the pest to be controlled. It can function as a bait and lure the pest into the trap where the pest is immobilized or killed by the above-described substance on the bottom of the body.

The apparatus is equipped with an additional container which can be used by e.g. the bees as drinking or feeding trough. The same container can also be filled with substances which serve as an attractant for pests and kill them upon ingestion.

When using the apparatus in different areas, e.g. in beehives or confined spaces, the trap is provided with a grid structure which, according to the dimensions of e.g. gaps, crevices, holes, slits or meshes therein, allows passage of organisms to be controlled. Bees are understood to include all individuals of a bee colony (female worker bees, male bees and the queen). For use in a beehive, the dimensions of the grid openings are specifically selected in such a way that the smallest adult animals in the bee colony, i.e. the worker bees, cannot pass through the grid openings. Both male bees (drones) and the queen are larger than the worker bees.

### Placing One or More Apparatus in the Beehive

The apparatus, which comprises one or more modules, is provided with one or more active substances and placed in the beehive, which comprises of a single storey, preferably horizontally either on the bottom board and/or the comb frame beneath the lid of the beehive.

If the beehive comprises of several storeys (frames), one or more apparatus can be distributed preferably horizontally in the beehive: on the bottom board and/or the comb frame of the single storeys, and beneath the lid of the beehive in the uppermost storey.

Use of the apparatus against bee pests such as varroa mite inside the hive

The volatile substance (e.g. thymol and/or an organic acid, preferably formic acid) introduced by means of the apparatus accumulates in the atmosphere (hive air) of the beehive.

As described above, evaporation of the volatile substance proceeds via a wick or, in the event of a solid, without participation of a wick.

The varroa mite is killed by formic acid. This applies to the adult, parasitic and blood-sucking varroa mites on the bees and also applies to the mite brood developing on the bee larvae in the wax-capped bee brood cells.

Dead mites fall off the bees and between the honeycombs on the apparatus below. Through the grid described above, which is impermeable to bees, the dead mites enter a container from which they cannot be carried away by the bees.

The apparatus can also be used without active substances in a beehive in order to determine the number of e.g. varroa mites dying naturally, i.e. without the use of one of the volatile substances described above. These mites will likewise fall through the grid and into the container below and cannot be transported out of the hive by the bees. The number of dead mites, i.e. the “natural mite mortality”, is indicative as to whether varroa control is required in the beehive.

When used in pest control, the apparatus is/are equipped with one of the above-described volatile substances (e.g. thymol and/or an organic acid, preferably formic acid) and reintroduced in the beehive.

Use of the Apparatus for Medication and/or Feeding of Bees Inside the Hive

Likewise for the control of e.g. varroa mites, the bees are fed a liquid, e.g. an organic acid, preferably oxalic acid, mixed with preferably sugar, corn syrup or honey dissolved in water. The opening of the container described above as drinking/feeding trough is such that the bees cannot enter the interior so as not to drown in a liquid contained therein.

The drinking/feeding trough can be used to administer medicaments or diets against bee pests familiar to those skilled in the art, such as varroa and tracheal mites, wax moths, small hive beetle, unicellular organisms, preferably nosema, Malpighi amoeba and/or bee diseases, such as European foulbrood, American foulbrood, amoebic dysentery, sacbrood, chalkbrood, and/or viral diseases, such as deformed wing virus (DWV), sacbrood virus (SBV), Kashmir bee virus (KBV), chronic bee paralysis virus (CBPV), acute bee paralysis virus (ABPV), black queen cell virus (BQCV). Medication is undiluted or mixed with preferably water or one or more feed substances of varying consistency, e.g. solid, powder, liquid, gel, paste, such as preferably sugar, corn syrup, pollen and/or honey.

Also, the drinking/feeding trough can be used in additional feeding of e.g. carbohydrate-rich feed, preferably sugar, corn syrup and/or honey, to overwinter the bees.

Moreover, the drinking/feeding trough can be used in additional feeding of e.g. protein-rich feed, preferably pollen, and/or carbohydrate-rich feed, preferably sugar, corn syrup and/or honey, for bee brood rearing.

### Use of the Apparatus Against Bee Pests Such as Small Hive Beetle Inside the Hive

The small hive beetle is an actively flying insect which is smaller than a bee. It enters the beehive primarily through the flight hole, and the females lay their eggs therein. Larvae hatch from the eggs and eat the hive from the inside. When the small hive beetle enters the beehive through the flight hole, it will be recognized as a “stranger” and attacked by the bees. The beetle will therefore look for protection in cracks and crevices in the hive or in empty cells on the combs.

With its grid structure and the container(s) situated below, the apparatus offers possible hiding places to pests smaller than bees, such as the small hive beetle. Owing to the grid structure, the bees have no access to the container(s).

Surprisingly, the small hive beetle is attracted by organic acids. For this reason, an organic acid, preferably formic acid, is additionally used as a bait for the small hive beetle. The beetle flees through the grid and into the container below, is destroyed or immobilized by an active ingredient and remains in the trap. The substance used to this end is kieselguhr, diatomaceous earth, diatom skeletons, hydrated lime, powdered stone or metal or ceramic, or any of the above-mentioned substances in micro-encapsulated form, or a sticky substance such as adhesive film, double-sided adhesive tape, adhesive gel, or glue, preferably caterpillar glue as used for protection against pests, e.g. in fruit growing.

In addition, the organic acid simultaneously used, preferably formic acid, lures the beetle into the trap and thus to the active ingredient described above, which immobilizes or destroys the beetle.

The small hive beetle is moving within the entire beehive from one hiding place to another, looking for protection even in the apparatus placed or distributed in the hive as described above.

All stages of e.g. insects and arachnids entering the container of the apparatus through the grid structure will be destroyed by the aforementioned substance and remain in the trap.

Apart from the adult small hive beetles, it is also possible that larvae thereof as well as wax moth larvae will creep into the container below the grid of the apparatus and remain dead inside the trap.

Use of the apparatus outside beehives, e.g. in beekeeper sheds, honey houses

One or more of the above-described apparatus provided with one or more active substance(s) can be used outside beehives.

In rooms where beekeeping goods and products of bees are stored and/or e.g. honeycombs are spun and/or stored, bee and storage pests, such as the dried-fruit moth, Vitula edmandsae, and the flour moth, Esphestia kuehniella, especially the great wax moth, Galleria mellonella, small wax moth, Achroia grisella, and the small hive beetle, as well as other insects known as pests to those skilled in the art can be controlled using one or more of the apparatus described above.

To combat the above bee and storage pests, one or more of the above-described apparatus are used with e.g. an organic acid, preferably acetic acid or formic acid.

The apparatus is/are placed in stacked frames including empty combs free of bees, as in the above-described multi-storey beehives. In addition, the flight hole is closed so as to hold the acid vapors in a confined space. The air/atmosphere in the confined space is saturated with the acid vapors, optionally using a wick as described above. These vapors thus can reach the above-mentioned pests, particularly e.g. adult wax moths which are killed in this way. Also, laid eggs and larvae of the wax moth are destroyed by organic acids, particularly acetic acid or formic acid.

The apparatus can be placed, exclusively or additionally, inside storage rooms as described above, preferably horizontally.

The organic acid, particularly acetic acid or formic acid can be used as a bait for the small hive beetle, for example. The bait lures the beetle through the grid structure of the above-described apparatus and into the container below. In the container the pest is destroyed by one of the above-described active ingredients and remains in the trap.

### Use of Pheromones in the Apparatus

Pheromones can be used as baits in addition to the above-described substances. Pheromones are volatile chemical messengers for the communication between individuals of a particular species.

One or more containers of an apparatus can be equipped e.g. with an adhesive film, adhesive cardboard, or a glue, provided with one or more pheromones.

Alternatively, one or more containers of the apparatus can be equipped e.g. with a wick provided with one or more pheromones.

Alternatively, one or more containers of the apparatus can be equipped e.g. with crystalline carrier substances provided with one or more pheromones.

Alternatively, one or more containers of the apparatus can be equipped e.g. with a gel as carrier substance, which is provided with one or more pheromones.

Use of the Apparatus against Pests in other Types of Application

Apart from beekeeping, the combination trap is intended for other fields of use, e.g. pest control in gastronomic business and kitchens, food manufacturing and processing industries, preferably bakeries, butcher shops; in agricultural business, in hygiene areas such as hospitals, therapy centers, medical practices; preferably in kitchens, bathrooms, in public changing rooms, toilets, swimming pools, saunas, sports facilities and similar institutions. In addition to these locations of use, simultaneous control of a plurality of pests of different types is also possible in private households. In places where one of these pests does not yet occur, the trap can be used in monitoring and prevention of the other pest or other pests.

Apart from bee pests, controlling and/or monitoring using one or more of the above-described apparatus is directed to pests and nuisance pests well-known to those skilled in the art, such as silverfish, woodlice, ants, preferably Pharaoh ants, army ants, e.g. Tapinoma melanocephalum, cockroaches, termites, bed-bugs, fleas, pest beetles of different families, preferably fat beetles, including e.g. fur beetles and museum beetles (e.g. in collections in museums); gloss beetles (Nitidulidae), preferably small hive beetle, weevils (Curculioniodae), preferably grain beetles, darkling beetles (Tenebrionidae), e.g. flour beetle and rice beetle; pests from the group of butterflies (Lepidoptera), such as dried-fruit moth, great and small wax moths, flour moths, clothes moth; or arachnids such as mites and ticks. Depending on the type of pest, different baits or control agents are used, preferably in one of the methods described above.

### LIST OF REFERENCE NUMBERS

FIGS. 1 and 2:
1 Shallow pan
2 Vertical bulge
3 Delineated area
4 Fabric
5 Horizontal pan surface
6 Grated lid with wrap

FIGS. 3 and 4:
1 Shallow box
2 Delineated area (compartment)
3 Fabric
4 Horizontal box bottom
5 Lid with grid structure

1. A combination agent comprising at least one organic acid, preferably formic acid and/or acetic acid, and
(I) silicates, in particular kieselguhr, preferably diatomaceous earth, and/or
(II) calcium compounds, preferably hydrated lime.

2. The combination agent according to claim 1, wherein formic acid and diatomaceous earth are spatially separated from each other.

3. A pharmaceutical agent, comprising the combination agent of claim 1, wherein said pharmaceutical agent, wherein said combination agent destroys in particular pests of bees.

4. The combination agent according to claim 1, wherein the combination agent destroys pests, in particular Varroa destructor and/or Aethina tumida and/or Galleria mellonella.

5. A kit comprising the combination agent according to claim 1 and optionally instructions for combining the contents of the kit.

6. Method for the prophylactic or therapeutic treatment of bees, particularly for combating pests and diseases of bees comprising providing a kit according to claim 5 and administering the combination agent of said kit to said bees in a amount effective for prophylaxis or therapeutic treatment of bees, particularly for combating pests and diseases of bees.

7. Method for monitoring pests of bees comprising providing a kit according to claim 5 and monitoring pests of bees via said kit.

8. A combination trap for preferably at least two bee pests, comprising the combination agent according to claim 1, wherein said combination agent is part of said combination trap.

9. The combination trap according to claim 8, comprising at least one essentially rectangular container which is divided by a barrier-like barrier-forming vertical center wall into at least two container portions situated in a horizontal plane, such that mixing of formic acid and diatomaceous earth preferably does not occur.

10. The combination trap according to claim 9, wherein the center wall is arranged substantially rectangularly and in such a way that in the container a small, preferably rectangular area is delineated in the horizontal plane of the container and a smaller defined area is positioned essentially centrally in the horizontal plane of the container.

11. The combination trap according to claim 10, wherein the delineated area has a fabric structure which has been contacted preferably with formic acid in such a way that it absorbs the formic acid and ensures evaporation thereof.

12. The combination trap according to claim 11, wherein the the fabric is designed as an evaporation element and preferably comprises an absorbent material selected from the group comprising paper, cardboard, ceramic, foam, woven or nonwoven textile material such as felt, fleece or spun thread.

13. The combination trap according to claim 11, wherein the horizontal plane of the container, which substantially encloses the small defined area, contains diatomaceous earth.

14. The combination trap according to claim 9, wherein a pan is covered with a wrap forming a cover which prevents contact of beneficial animals, especially bees, with the substances.

15. The combination trap according to claim 14, wherein the cover has slits, holes and/or meshes preventing bees from passing through and designed in such a way that little or preferably no diatomaceous earth is swirled up from the trap by air flow swirls, especially in a beehive.

16. The combination trap according to claim 9, wherein the container comprises acid-proof materials such as plastics or metals.

17. A method for monitoring and/or combating pests of bees comprising providing the combination trap of claim 8 and monitoring and/or combating pests of bees via said trap.

18. A method for prevention or protection of regions or beehives not yet infested with Aethina tumida and/or Varroa destructor comprising providing the combination trap of claim 8 and preventing infestation of or protecting regions or beehives not yet infested with Aethina tumida and/or Varroa destructor via said trap.

19. A method for prevention of or protection from bee pests outside a beehive, particularly in stock buildings, comprising providing the combination trap of claim 8 and preventing or protecting a beehive from bee pests outside the beehive, particularly in stock buildings, wherein the preferred organic acid is acetic acid.

20. A method for controlling Varroa destructor and/or Aethina tumida in a beehive, wherein in a container having two spatially separated reservoirs an essentially constant level of an evaporation rate is generated in one of said reservoirs, wherein the evaporative liquid comprises an organic acid, preferably formic acid, the second spatially separated zone comprises silicates, diatomaceous earth, calcium compounds, preferably hydrated lime, and the second zone essentially encloses the reservoir with evaporative liquid.
